(19) United States
(12) Patent Application Publication
(10) Pub. No.: US 2026/0192223 A1
(43) Pub. Date: Jul. 9, 2026

(54) FLUOROCARBON-FREE FILTRATION MEDIA

(71) Applicant: UNIFRAX I LLC, Tonawanda, NY (US)

(72) Inventors: Mauricio Munhoz DE SOUZA, Amherst, NY (US); Dorothy STUART, Clifton Park, NY (US); Laurent RENOUX, Hennebont (FR); Wayne GIBBONS, Milton, NH (US)

(21) Appl. No.: 19/559,229

(22) Filed: Mar. 6, 2026

Related U.S. Application Data
(63) Continuation of application No. PCT/US2024/047268, filed on Sep. 18, 2024.
(60) Provisional application No. 63/583,339, filed on Sep. 18, 2023.

(51) Int. Cl. B01D 39/20; D04H 1/4218; D04H 1/645

(52) U.S. Cl. CPC B01D 39/2024; D04H 1/4218; D04H 1/645; B01D 2239/0464; B01D 2239/0478; B01D 2239/0618; B01D 2239/10; B01D 2239/1275; B01D 2239/1291; D10B 2401/062; D10B 2401/063; D10B 2505/04

(57) ABSTRACT

A fluorocarbon-free filtration media includes a fluorocarbon-free additive and mimics one or more properties of traditional fluorocarbon-containing filtration media. A method of making the fluorocarbon-free filtration media includes forming a nonwoven web of microglass fibers and applying the fluorocarbon-free additive. The fluorocarbon-free additive can be added before incorporating a binder, with the binder, or both before and with the binder.

### CROSS-REFERENCE TO RELATED APPLICATIONS

The present application is a continuation of PCT International Patent Application No. PCT/US2024/047268, filed Sep. 18, 2024, which claims priority to U.S. Provisional Application Ser. No. 63/583,339, filed on Sep. 18, 2023, entitled “Fluorocarbon-Free Filtration Media,” each of which is incorporated herein by reference in their entireties.

### FIELD OF THE DISCLOSURE

The present disclosure relates to filtration media including fluorocarbon-free repellents. More particularly, the disclosure relates to nonwoven filtration media having water, alcohol, or oil repellency without the use of per- and polyfluoroalkyl substances (PFAS).

### BACKGROUND

PFAS are used in the nonwovens industry to produce filtration media with specific characteristics. PFAS imparts water, alcohol, and/or oil repellency to the media and allows the final filter to be used in harsh environments where those properties are important. These chemicals are very efficient, wherein a small amount of added PFAS can provide said repellency properties without impacting other characteristics of the filtration media, such as resistance, penetration, tensile strength, and the like.

However, many industries are attempting to reduce or eliminate the use of PFAS for a variety of reasons. As such, there remains a need for PFAS alternatives that can provide similar repellency without affecting other properties.

### DETAILED DESCRIPTION

The following is a description of a non-limiting method of the present disclosure used to create filtration media without the use of per- and polyfluoroalkyl substances (PFAS). Although the claimed subject matter will be described in terms of certain embodiments and examples, other embodiments and examples, including embodiments and examples that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value (either lower limit or upper limit value) and ranges between the values of the stated range.

The present disclosure provides microglass fiber filtration media without any PFAS chemical added while maintaining the main media properties. Suitable microglass fibers may include those disclosed in U.S. Patent Application Publication No. 20190309455 A1, the disclosure of which is incorporated herein in its entirety.

Importantly, potential PFAS substitutes need to not substantially interfere with the remaining chemicals of the formulation (i.e., chemical compatibility). In this regard, chemical compatibility of a PFAS substitute may be quantified as any one or more of the following, relative to a standard PFAS-containing filtration media: a basis weight (lb/ft²) within 10%, 5%, 2%, or 1% of standard; no more than 30%, 20%, or 10% increase from standard in loss on ignition (LOI) at 1000° C.; tensile strength (sum of MD and CD; gram force/in; gf/in) within 30%, 25%, or 20% of standard; stiffness (mgf) within 10% or 5% of standard; an Alpha (index of filtration efficiency; ISO 4572; a ratio between penetration of particles and media pressure drop; a higher Alpha means better filtration) within 10% or 5% of standard; and/or a water column value (in.; measuring water repellency) within 40%, 20% of 10% of standard. In some embodiments, chemical compatibility means that the media filter including the PFAS substitute has one or more of the following properties: a basis weight of 45 to 51 lb/ft²; an LOI of 4.5 to 7.5%; an MD tensile strength of at least 2000 gf/in; a CD tensile strength of at least 1100 gf/in; an MD+CD tensile strength of at least 3100 gf/in; a DF tensile strength (reflecting ability to maintain strength after folding) of at least 600 gf/in; an MD stiffness of 900 to 1600 mgf; a CD stiffness of 275 to 400 mgf; an MD+CD stiffness of 1175 to 2000 mgf; an Alpha value of 8 to 15 or 11 to 15; a water column value of 15 to 30 inches; an oil resistance index (ISO 14419) of at least 3; and/or a Z force of at least 3000 gf.

In some embodiments, the PFAS alternative comprises a mixture of water repellents, alcohol repellents, and/or oil repellents or a composition that is repellent to two or more of water, alcohol, and oil. In some embodiments, the PFAS alternative comprises a silicone-based compound, a urethane-based compound, an acrylate, or combinations thereof. Examples of commercially available repellents that may be included in the PFAS alternative are, without limitation: XF-5005 (available from Daikin Industries, Ltd.; a water-based acrylate emulsion that is weakly cationic); FIBRALAST 506N/506 (available from AGC Chemicals; a non-ionic emulsion with some silicone functional groups); XIAMETER MEM8035 (available from Dow Inc.; silicone based); and ZELAN CA-72 (available from Archroma; urethane based).

In some embodiments, the fluorocarbon filtration media is formed by air-laying, wet-laying (such as a paper-making type process), or vacuum-forming. A wet-laying process may include a pulping step in which a dispersion of fibers is mixed into a homogenous pulp and optionally refined (e.g., a beater may be used to obtain a desired fiber length), a draining step in which the pulp is drained (e.g., via gravity or with the aid of a vacuum) to form a mat (or a web) of fibers, a binding step in which a binder slurry is formed and applied to the mat of fibers (e.g., the mat may be submerged in the binder slurry), and a drying step in which the binder-impregnated mat of fibers is dried (e.g., in an oven at elevated temperature).

In some embodiments, the process used to add the PFAS alternative can impact the final performance of the product. In some embodiments, the PFAS alternative may be included as a “beater add”, meaning the PFAS alternative is added to a web of fibers before applying the binder, e.g., once the web is formed in the vacuum drainage stage. For instance, the PFAS alternative may be sprayed or poured on the web of fibers, or the web of fibers may be submerged in the PFAS alternative. During the beater add, the PFAS alternative is impregnated throughout the thickness of the media and retained in the porosity of the product. In some embodiments, the PFAS alternative may be included as a “binder add,” meaning the PFAS alternative is added into the binder slurry formulation together with the other binder(s) normally used to produce a filtration media (e.g., latex). In such embodiments, the PFAS alternative needs to be compatible with the binder formulation in order to not interfere with the stability of the slurry. In some embodiments, the PFAS alternative may be both a beater add and a binder add or the PFAS alternative may include multiple components that are independently beater added and/or binder added.

In some embodiments, the binder may include an organic binder, an inorganic binder, or combinations thereof. The organic binder may include polymer emulsions, solvent-based polymers, solvent-free polymers, starches, organic binder fibers, or mixtures thereof. The polymer emulsions may include latex, natural rubber latex, styrene-butadiene latex, butadiene-acrylonitrile latex, latexes of acrylate/methacrylate polymers/copolymers, or mixtures thereof. The solvent-based polymers may include acrylics, polyurethanes, vinyl acetate, celluloses, rubber-based organic polymers, or mixtures thereof. The solvent-free polymers may include natural rubber, styrene-butadiene rubber, elastomers, or combinations thereof. The starches may include potato starch, corn starch, or mixtures thereof. The organic binder fibers may include polyvinyl alcohol (“PVA”) fibers, micro-fibrillated cellulose fibers, or combinations thereof. The inorganic binder may include a colloidal inorganic oxide dispersion including at silica, alumina, titania, zinc, magnesia, zirconia, or mixtures thereof.

In some embodiments, the PFAS alternative may be heat treated. For example, for a wet-laid fluorocarbon filtration media, the drying step may be modified to increase the heat applied to the PFAS alternative. In some embodiments, the fluorocarbon filtration media may undergo a post-drying heat treatment at a temperature of at least 200° C., at least 300° C., or at least 500° C.

### Example

Sample filtration media were produced in a pilot roto-former with the additives and addition methods shown in TABLE 1 below. Performance of said samples was tested and is summarized in TABLE 1.

TABLE 1

| | Basis | | | Tensile | | Water |
|---|---|---|---|---|---|---|
| | weight | LOI | Stiffness | strength | | column |
| Formulation | (lb/ft²) | (%) | (mgf) | (gf/in) | Alpha | (in.) |
| Control | 52.3 | 6 | 767 | 2023 | 11.7 | 30 |
| (standard | | | | | | |
| media with | | | | | | |
| fluorocarbon) | | | | | | |
| XF5005 | 51.4 | 6.4 | 906 | 2080 | 12.2 | 28 |
| added on | | | | | | |
| binder | | | | | | |
| MEM8035 | 52.5 | 7.5 | 648 | 1897 | 11.1 | 42 |
| on beater | | | | | | |
| and XF5005 | | | | | | |
| on binder | | | | | | |

As shown above, it is possible to provide a filtration media that has no PFAS chemical added that meets most of the standard properties of a PFAS-including media.

Considerations must be made regarding material and production costs, as well as environmental impact of any PFAS alternatives.

Although the present disclosure has been described using preferred embodiments and optional features, modification and variation of the embodiments herein disclosed can be foreseen by those of ordinary skill in the art, and such modifications and variations are considered to be within the scope of the present disclosure. It is also to be understood that the above description is intended to be illustrative and not restrictive. For instance, it is noted that the diameter, length, thickness, and density values described above are illustrative only and can be readily adjusted by one of ordinary skill in the art to fit a wide range of potential reactors and processes. Many alternative embodiments will be apparent to those of ordinary skill in the art upon reviewing the above description. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the disclosure.

What is claimed is:

1. A method of making a filtration media, comprising:
forming a nonwoven web of microglass fibers;
impregnating the nonwoven web with a binder to form a bound web;
applying a fluorocarbon-free additive to the nonwoven web and/or the bound web; and
drying the bound web to form the filtration media;
wherein the filtration media does not comprise fluorocarbons; and
wherein the fluorocarbon-free additive is a silicone-based compound, a urethane-based compound, an acrylate, or combinations thereof.

2. The method of claim 1, wherein applying the fluorocarbon-free additive comprises impregnating the nonwoven web with the fluorocarbon-free additive.

3. The method of claim 2, wherein applying the fluorocarbon-free additive further comprises applying the fluorocarbon-free additive to the bound web.

4. The method of claim 1, wherein applying the fluorocarbon-free additive comprises applying the fluorocarbon-free additive to the bound web.

5. The method of claim 1, wherein the filtration media has an alpha value of at least 8.

6. The method of claim 1, wherein the filtration media has an oil resistance index of at least 3.

7. The method of claim 1, wherein the filtration media is water repellant, alcohol repellent, and/or oil repellent.

8. The method of claim 1, further comprising heat treating the filtration method at a temperature of at least 200° C. after drying.

9. The method of claim 1, wherein the fluorocarbon-free additive comprises a first additive and a second additive, wherein the first additive and the second additive are each a silicone-based compound, a urethane-based compound, an acrylate, or combinations thereof and wherein the first additive is different from the second additive.

10. The method of claim 9, wherein applying the fluorocarbon-free additive comprises applying both of the first additive and the second additive together to the nonwoven web and/or the bound web.

11. The method of claim 9, wherein applying the fluorocarbon-free additive comprises applying the first additive to the nonwoven web and applying the second additive to the bound web, wherein the first additive is not added to the bound web and the second additive is not added to the nonwoven web.

12. A filtration media produced by the method of claim 1.

13. The filtration media of claim 12, comprising a basis weight of 45 to 51 lb/ft².

14. The filtration media of claim 12, comprising a loss on ignition of 4.5 to 7.5%.

15. The filtration media of claim 12, comprising a machine direction (MD) tensile strength of at least 2000 gf/in.

16. The filtration media of claim 12, comprising a cross-machine direction (CD) tensile strength of at least 1100 gf/in.

17. The filtration media of claim 9, comprising a machine direction (MD)+cross-machine direction (CD) tensile strength of at least 3100 gf/in.

18. The filtration media of claim 12, comprising a machine direction (MD) stiffness of 900 to 1600 mgf.

19. The filtration media of claim 12, comprising a cross-machine direction (CD) stiffness of 275 to 400 mgf.

20. The filtration media of claim 12, comprising a machine direction (MD)+cross-machine direction (CD) stiffness of 1175 to 2000 mgf.
